(19) United States
(12) Patent Application Publication
(10) Pub. No.: US 2002/0050195 A1
(43) Pub. Date: May 2, 2002

(54) Method and apparatus for cutting a sheet-shaped material

(76) Inventors: Kazuyuki Matsumoto, Tokyo-to (JP); Yoshinobu Sakemi, Tokyo-to (JP)

Correspondence Address: LADAS & PARRY, 224 SOUTH MICHIGAN AVENUE, SUITE 1200, CHICAGO, IL, 60604, US

(21) Appl. No.: 09/964,062

(22) Filed: Sep. 26, 2001

(30) Foreign Application Priority Data
Nov. 2, 2000 (JP) P2000-336542

(51) Int. Cl. B26D 3/00

(52) U.S. Cl. 83/13; 83/73

(57) ABSTRACT

A method for cutting a sheet-shaped material, comprises the steps of: (a) measuring, immediately before cutting a sheet-shaped material heated, temperature of the sheet-shaped material; (b) determining expansion of the sheet-shaped material based on the temperature thus detected and a room temperature; and (c) cutting the sheet-shaped material in anticipation of the expansion thus determined.

### BACKGROUND OF THE INVENTION

1. Field of the Invention

The present invention relates a method and an apparatus for cutting a sheet-shaped material, which permits to accurately and smoothly cut a sheet-shaped material formed of synthetic resin or the like.

2. Description of the Related Art

Various sheet-shaped materials such as Fresnel lens sheets, lenticular lens sheets or the like can be manufactured in accordance with a method as illustrated in FIGS. 7 and 8.

FIGS. 7 and 8 illustrate an example of a method for manufacturing a Fresnel lens sheet. First, a forming die 1 for the Fresnel lens is prepared and ultraviolet ray curing type resin 2 in the form of liquid is dripped on a side of the forming die 1 (see FIG. 7(A)). Then, a substrate sheet 3 formed of rigid synthetic resin is placed on the forming die 1. The substrate sheet 3 and the forming die 1 with the dripped resin are supplied into a space between a pair of nip rollers 4 and 4 (see FIG. 7(B)). A pressing operation, which is applied to the forming die 1 and the substrate sheet 3 by the nip rollers 4 and 4, causes the liquid ultraviolet ray curing type resin to flow and spread between the forming die 1 and the substrate 3. The ultraviolet ray curing type resin 2 is supplied in a relatively large amount so as to spread all over recess portions of the forming die 1. A superfluous amount of resin 2a, 2ax, 2ay flows out of the forming die 1 to reach the outside of the four peripheral sides thereof when carrying out a pressing operation by means of the nip rollers 4 and 4. A receiving member 1a for receiving the superfluous amount of resin 2a, 2ax, 2ay is provided on the four peripheral sides of the forming die 1 to project outside therefrom. The forming die 1, which has passed the nip rollers 4 and 4, is subject to radiation of ultraviolet ray from above the substrate sheet 3 to cure the ultraviolet ray curing type resin 2. After completion of curing, the substrate onto which the ultraviolet ray curing type resin 2 adheres, is removed from the forming die 1, thus preparing a sheet 5 of Fresnel lens as a semi-finished product (see FIGS. 7(C) and 8(A)).

The thus prepared sheet 5 of Fresnel lens as the semi-finished product has a larger size than a prescribed size of the Fresnel lens sheet as the finished product and is provided with unwanted portions onto which the superfluous amount of resin 2a, 2ax, 2ay adheres. Accordingly, the sheet 5 is therefore cut along the four cutting lines CL1, CL2, CL3 and CL4 as shown in FIG. 8(A). As a result, there is obtained a square or rectangular sheet 6 of Fresnel lens having a prescribed size as shown in FIG. 8(B).

It is necessary to cut the sheet 5 of Fresnel lens as the semi-finished product along the four cutting lines to remove the unwanted portions from the sheet 5 as described above. There has been used a conventional apparatus for cutting a sheet-shaped material, which is disclosed in Japanese Laid-Open Patent Application No. H11-300687, to prevent cracks from occurring on the finished product side and burrs from occurring on the cutting surface when carrying out the above-mentioned cutting operation.

The conventional apparatus for cutting a sheet-shaped material is provided with a pair of blades, i.e., the upper and lower blades, and holding members. The upper and lower blades face each other in the vertical direction so that the sheet-shaped material 5 of the semi-finished product to be supplied horizontally is placed between the upper and lower blades. The holding members, which are made of material having a cushioning property, are disposed on the opposite sides of the lower blade, respectively. The holding members come into contact with the sheet-shaped material 5 when cutting it by means of the upper and lower blades. When the cutting operation starts to cut the sheet-shaped material 5, the upper blade comes into contact with the sheet-shaped material 5 prior to contact of the lower blade with the sheet-shaped material 5 so as to urge the sheet-shaped material on the holding members to resiliently bend it, and then, the lower blade comes into contact with the sheet-shaped material 5 thus bent.

In the process for forming the sheet-shaped material 5 as shown in FIGS. 7(A), 7(B) and 7(C), a metallic mold serving as the forming die 1 is previously heated in order to improve fluidity of the ultraviolet ray curing type resin 2 on the forming die 1. As a result, the sheet-shaped material 5 as the semi-finished product removed from the forming die has a high temperature than a room temperature. When the cutting operation is applied to the sheet-shaped material as heated, the resultant sheet-shaped material 6 as the finished product shrinks, thus making it impossible to provide a finished product having the standardized size. In view of such circumstances, the cutting operation has conventionally applied to the sheet-shaped material 5 with the use of the cutting apparatus after the lapse of time during which the temperature of the sheet-shaped material 5 as the semi-finished product decreases to the room temperature. Such a cutting operation however leads to a low manufacturing efficiency. In addition, resin, which has been cured before the cutting operation, tends to cause cracks to occur on the finished product side, leading to problems.

### SUMMARY OF THE INVENTION

An object of the present invention is therefore to provide a method and an apparatus for cutting a sheet-shaped material, which permits to solve the above-mentioned problems.

In order to attain the aforementioned object, the method of the first aspect of the present invention for cutting a sheet-shaped material, comprising the steps of:

(a) measuring, immediately before cutting a sheet-shaped material heated, temperature of the sheet-shaped material;

(b) determining expansion of the sheet-shaped material based on said temperature thus detected and a room temperature; and

(c) cutting the sheet-shaped material in anticipation of said expansion thus determined.

According to the features of the first aspect of the present invention, it is possible to cut the sheet-shaped material immediately after formation thereof without waiting until the temperature of the sheet-shaped material descends to the room temperature, to provide a finished product having the standardized size, thus improving manufacturing efficiency. In addition, it is possible to cut the sheet-shaped material at a higher temperature than the room temperature, and hence to prevent cracks from occurring on the finished product even when the sheet-shaped material has a high hardness.

In accordance with the second aspect of the present invention, said step (a) may comprise measuring the temperature of portions of the sheet shaped-material, which correspond to a plurality of prescribed cutting lines along which the sheet-shaped material is to be cut; said step (b) may comprise determining expansion of each of said portions of the sheet-shaped material; and said step (c) may comprise cutting the sheet-shaped material along said prescribed cutting lines in anticipation of said expansion of each of said portions of the sheet-shaped material. According to such features, it is possible to carry out an appropriate cutting operation to provide the finished product having the standardized size even when the expansions of the above-mentioned portions of the sheet-shaped material, which correspond to the cutting lines, differ from each other.

In order to attain the aforementioned object, the apparatus of the third aspect of the present invention comprises:

a cutting unit having a pair of blades;

a temperature sensor for measuring temperature of a sheet-shaped material heated;

a computing unit for calculating expansion of the sheet-shaped material based on said temperature measured by said temperature sensor and a room temperature; and

a supply unit for supplying the sheet-shaped material into said cutting unit based on output from said computing unit.

According to the feature of the third aspect of the present invention, it is possible to automatically measure the temperature of the sheet-shaped material and cut it smoothly to an appropriate size in anticipation of shrinkage.

In accordance with the fourth aspect of the present invention, said temperature sensor may have a function of measuring the temperature of portions of the sheet shaped-material, which correspond to a plurality of prescribed cutting lines along which the sheet-shaped material is to be cut; said computing unit may have a function of determining expansion of each of said portions of the sheet-shaped material to output signals for said portions; and said supply unit may have a function of supplying the sheet-shaped material into said cutting unit based on said signals for said portions from said computing unit.

According to the features of the forth aspect of the present invention, the temperature sensor measures the temperature of the portions of the sheet shaped material, which correspond to the cutting lines, for example, the front and rear half portions thereof in its traveling direction, the computing unit determines expansion of each of these portions to output signals for the portions and the supply unit supplies the sheet-shaped material into the cutting unit based on the signals for the portions from the computing unit. It is therefore possible to carry out an appropriate cutting operation to provide the finished product having the standardized size even when the expansions of the above-mentioned portions of the sheet-shaped material, which correspond to the cutting lines, for example the front and rear half portions thereof, differ from each other.

### BRIEF DESCRIPTION OF THE DRAWINGS

FIG. 1 is a plan view of an apparatus of the present invention for cutting a sheet-shaped material;

FIG. 2 is a right-hand side view of the apparatus of the present invention for cutting the sheet-shaped material;

FIG. 3 is a cross-sectional view cut along the III-III line in FIG. 1;

FIG. 4 is a view having a viewing direction based on the IV-IV line in FIG. 1;

FIGS. 5(A), 5(B) and 5(C) are descriptive view of a cutting process of the sheet-shaped material, having a viewing direction based on the III-III line in FIG. 1;

FIGS. 6(A), 6(B) and 6(C) are descriptive view of the cutting process of the sheet-shaped material, having a viewing direction based on the IV-IV line in FIG. 1;

FIGS. 7(A), 7(B) and 7(C) are cross-sectional views illustrating a process for forming the sheet-shaped material, and more specifically,

FIG. 7(A) illustrates a forming die on which ultraviolet ray curing type resin is applied,

FIG. 7(B) illustrates the forming die and a substrate sheet, which are subjected to a pressing process and

FIG. 7(C) illustrates a sheet-shaped material formed as the semi-finished product; and

FIG. 8(A) is a plan view illustrating the sheet-shaped material as the semi-finished product and

FIG. 8(B) is a plan view illustrating the sheet-shaped material as the finished product.

### DETAILED DESCRIPTION OF THE PREFERRED EMBODIMENTS

Now, embodiments of the present invention will be described in detail below with reference to the accompanying drawings.

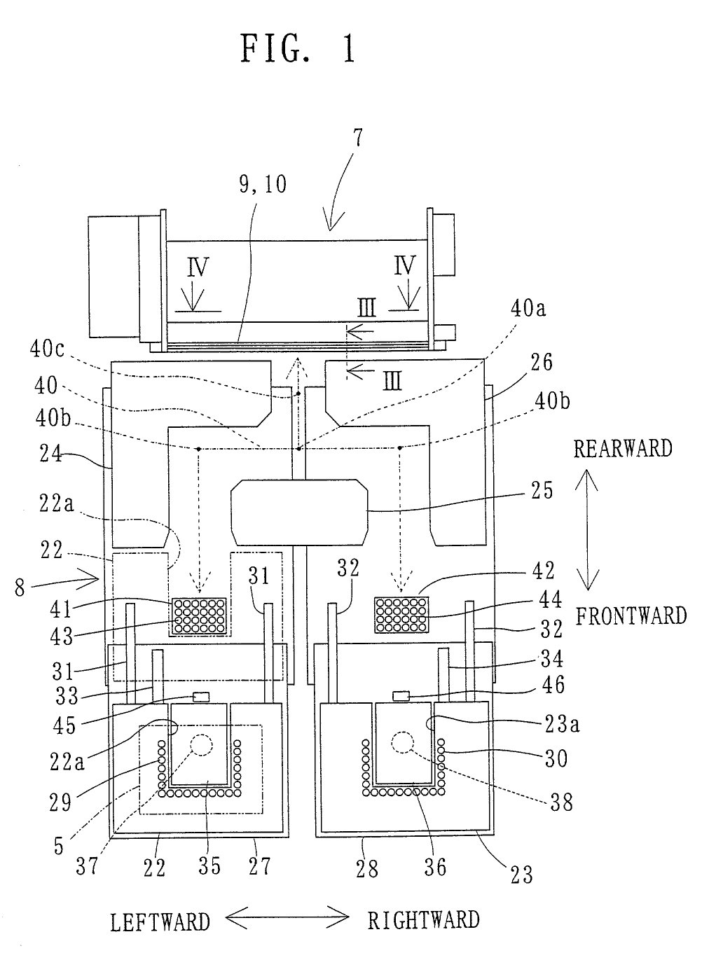

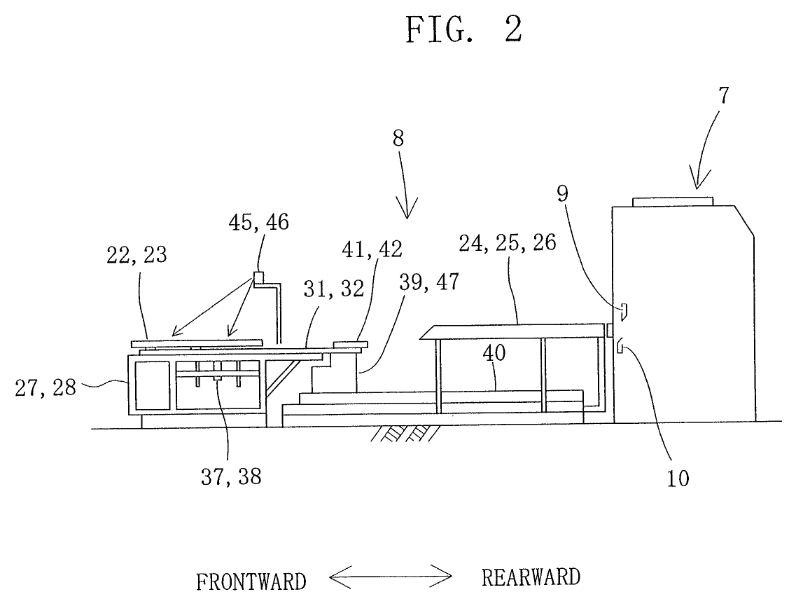

As shown in FIGS. 1 and 2, an apparatus of the present invention for cutting a sheet-shaped material has a cutting unit 7 and a supply unit 8 for supplying a sheet-shaped material 5 as the semi-finished product into the cutting unit 7. The cutting unit 7 is disposed on the rear side in the cutting apparatus and the supply unit 8 is disposed on the front side therein.

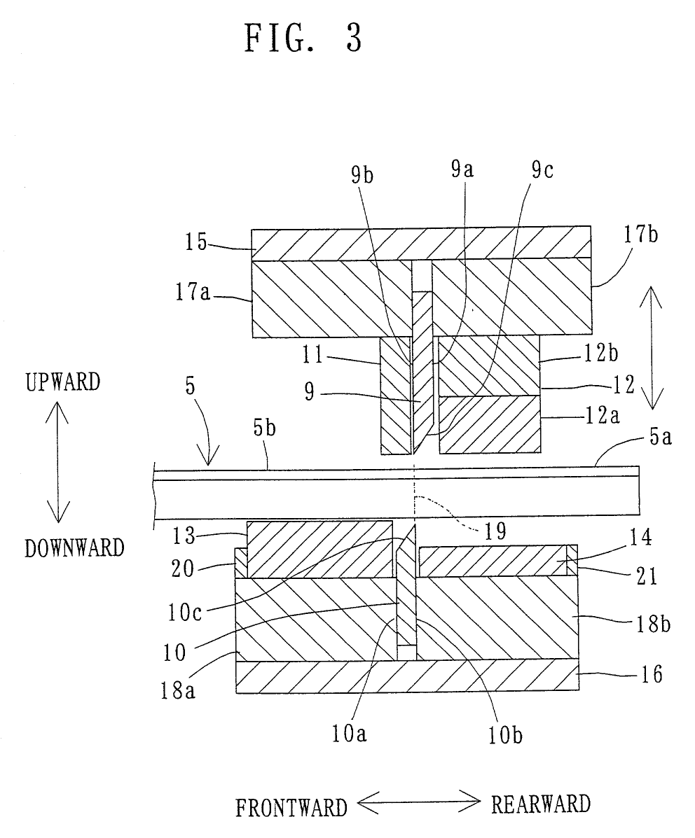

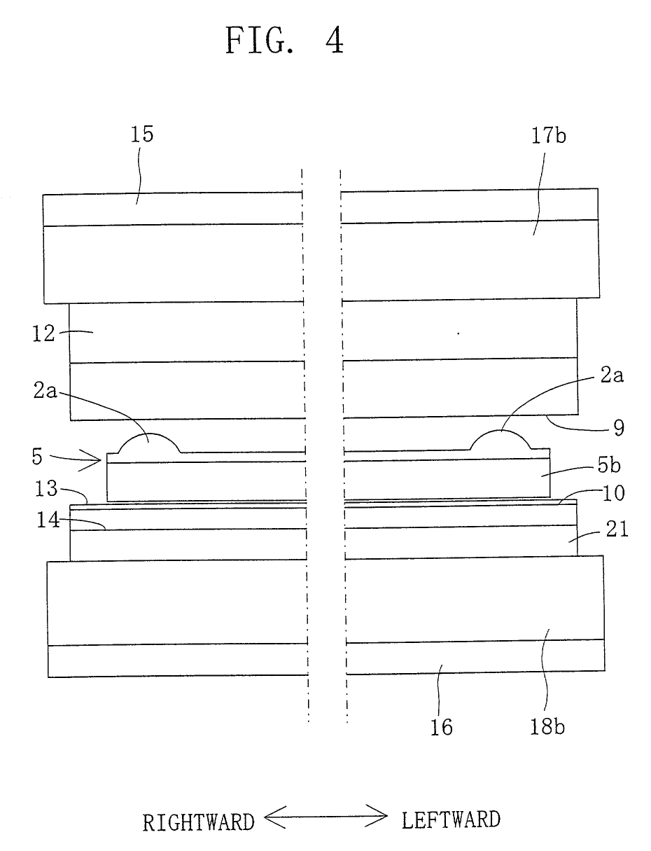

The cutting unit 7 has a pair of blades, i.e., the first and second blades 9 and 10, and holding members 11, 12, 13 and 14 having a cushioning property, as shown in FIGS. 3 and 4. The first and second blades 9 and 10 face each other in the vertical direction so that the sheet-shaped material 5 to be cut, which is to be supplied horizontally, is placed between the first (i.e., upper) blade 9 and the second (i.e., lower) blade 10. The holding members may be classified into the first holding members 11 and 12, which are disposed on the opposite sides of the upper blade 9, respectively, and the second holding members 13 and 14, which are disposed on the opposite sides of the lower blade 10, respectively.

The upper and lower blades 9 and 10 extend in the transverse direction in the cutting unit 7. The upper blade 9 is clamped between upper clamping members 17a and 17b, which are secured on an upper base member 15. The lower blade is clamped between lower clamping members 18a and 18b, which are secured on a lower base member 16. There is carried out a positional adjustment of the upper and lower blades 9 and 10 relative to the upper and lower base members 15 and 16 by means of the clamping members 17a, 17b, 18a and 18b, and then, the upper and lower blades 9 and 10 are stationarily held on the upper and lower base members 15 and 16. The lower base member 16 is fixed on a frame of the cutting unit 7 together with the lower blade 10. The upper base member 15 are supported on the frame of the cutting unit 7 so as to be movable in the vertical direction together with the upper blade 9. The pair of blades 9 and 10 may be placed as to extend horizontally and the sheet-shaped material may be supplied vertically. Any one of the blades 9 and 10 may be movable or both of them may be movable each other. As shown in FIG. 3, when the cutting operation starts, the sheet-shaped material 5 is inserted between the upper and lower blades 9 and 10 form the front side toward the rear side. It moves to a prescribed position and then stays still. A single reciprocating motion of the upper blade 9 causes a useless end portion 5a to be cut from a product 5b side. In the embodiment as shown in the drawings, the sheet-shaped material 5 is supplied so that the surface of the formed body such as a lens made of ultraviolet ray curing type resin 2 or the like is directed to the upper blade 9. The sheet-shaped material 5 may be supplied so that the surface of the formed body is directed to the lower blade 10.

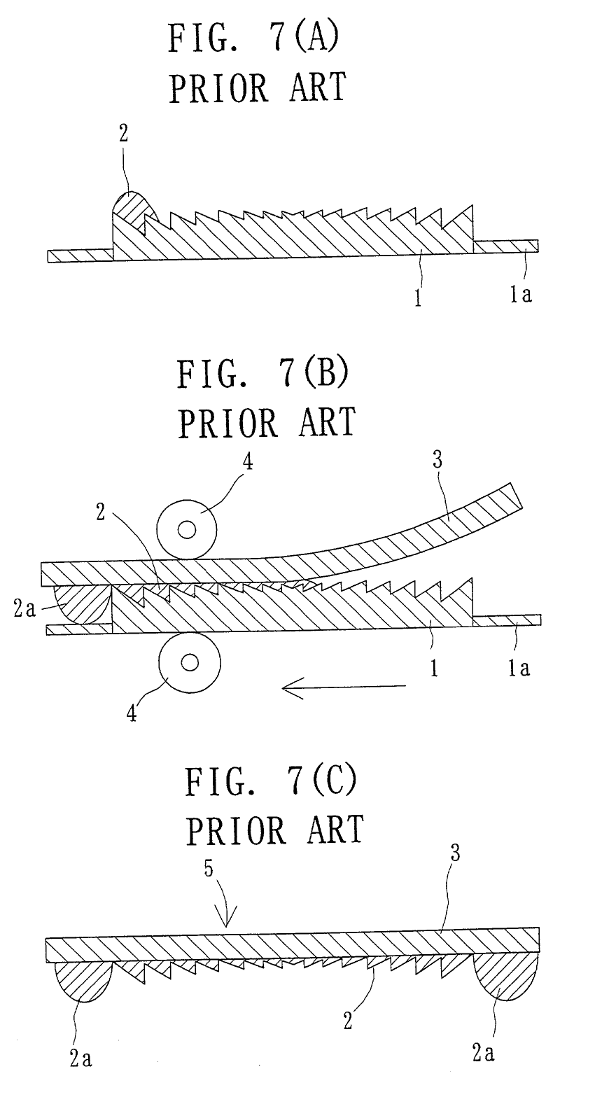

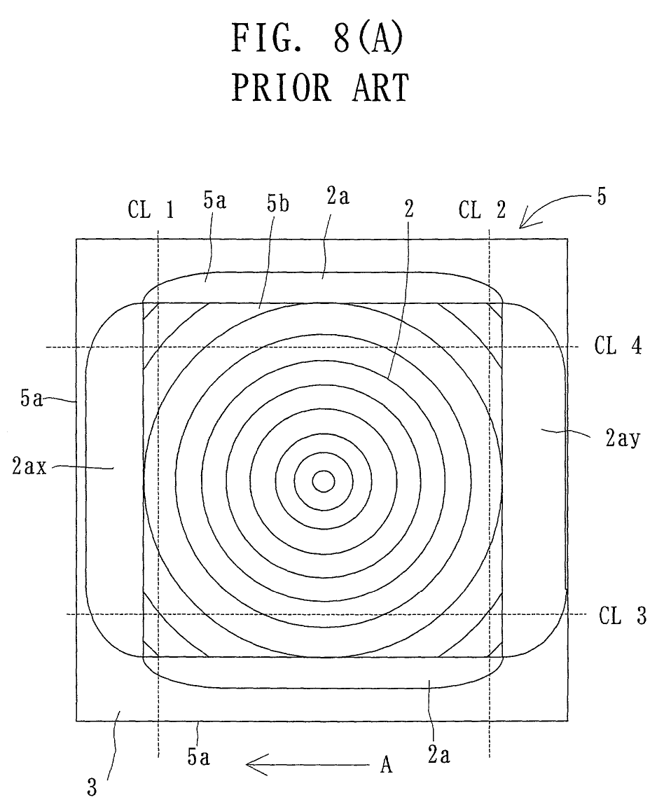

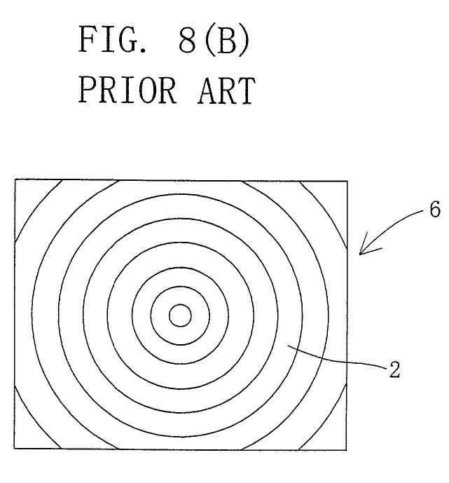

As shown in FIG. 3, the edges of the upper and lower blades 9 and 10 have slant faces 9c and 10c, respectively, which connect primary faces 9b and 10b with secondary faces 9a and 10a, respectively. The primary face 9b of the upper blade 9 and the secondary face 10a of the lower blade 10 are directed frontward and the secondary face 9a of the upper blade 9 and the primary face 10b of the lower blade 10 are directed rearward. More specifically, the primary face 9b of the upper blade 9 and the primary face 10b of the lower blade 10 are substantially aligned with each other along a plane 19 perpendicular to the sheet-shaped material 5 and the secondary faces 9a and 10a of the upper and lower blades 9 and 10 are directed to the opposite directions to each other. Contact of the upper blade 9 with the superfluous amount of resin 2a, 2ax, 2ay adhering, as shown in FIGS. 7 and 8, on the sheet-shaped material 5 as the semi-finished product causes an excessively large stress to occur on the sheet-shaped material 5. Arrangement in which the primary face 9b and the secondary face 9a of the upper blade 9 are directed to the opposite directions to those of the primary face 10b and the secondary face 10a of the lower blade 10 so that the primary face 9b of the upper blade 9 and the primary face 10b of the lower blade 10 are substantially aligned with each other along the above-mentioned plane 19 in accordance with the embodiment of the present invention, makes it possible to reduce the stress applied on the sheet-shaped material 5. It is therefore possible to prevent cracks from occurring on the product 5b side of the sheet-shaped material 5.

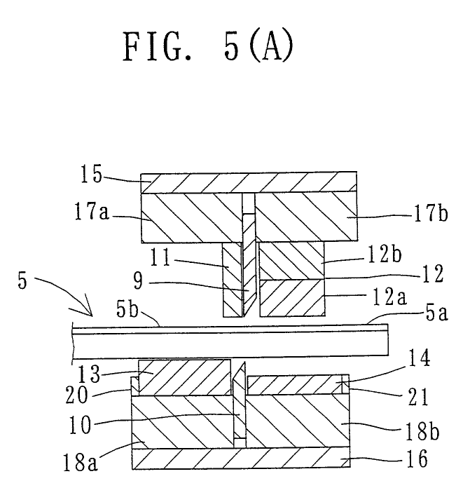

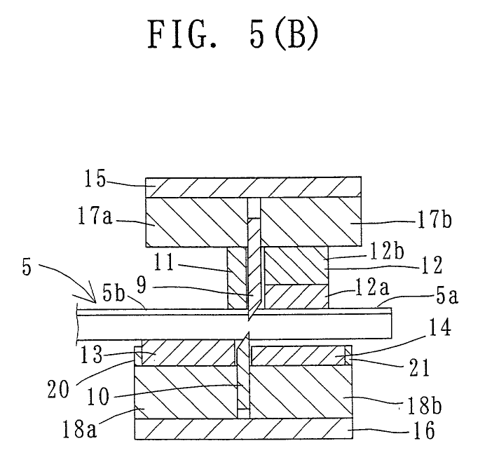

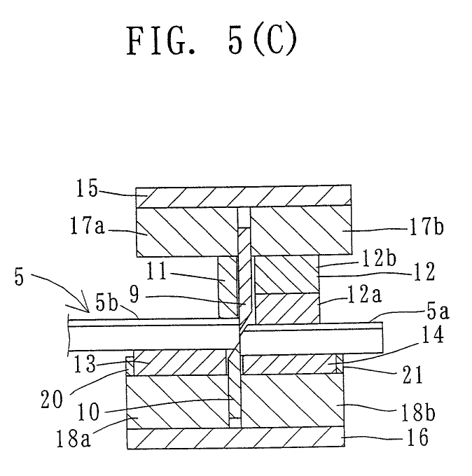

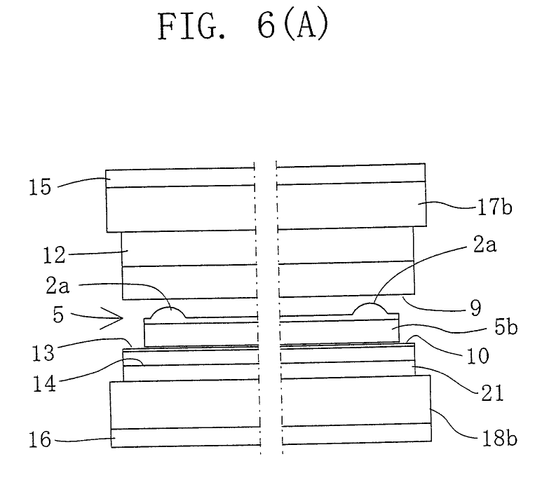

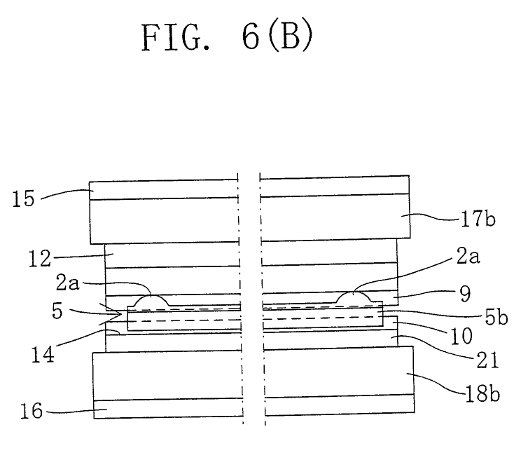

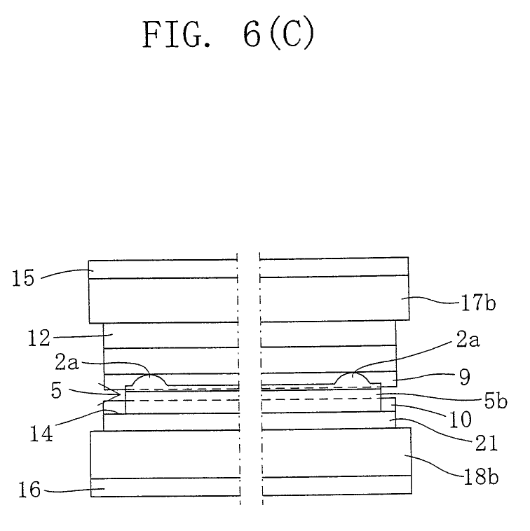

There is made a specific arrangement in which the blade edges of the upper blade 9 and the lower blade 10 do not come into contact with each other in the vertical direction so as to provide an appropriate gap between these blade edges even when the upper blade 9 moves to the closest position to the lower blade 10, as shown in FIGS. 5(B) and 6(B). Such a specific arrangement makes it possible to form notches on the opposite surfaces of the sheet-shaped material 5 by means of the upper and lower blades 9 and 10 during the first half of the single cutting process and then break the portion of the sheet-shaped material 5, which corresponds to the above-mentioned appropriate gap between the blade edges, during the second half thereof. It is therefore possible to accurately cut the sheet-shaped material 5 without causing cracks even when the sheet-shaped material 5 includes the substrate sheet 3 formed of hard material.

The holding members 11 and 12 are disposed on the opposite sides of the upper blade 9 as shown in FIGS. 3 and 4, in addition to the holding members 13 and 14 disposed on the opposite sides of the lower blade 10. When the notches are formed on the opposite surfaces of the sheet-shaped material 5 by the upper and lower blades 9 and 10, the sheet-shaped material 5 is held from the opposite surfaces by means of the holding members 11, 12, 13 and 14. The elastic deformation of the holding members 11, 12, 13 and 14 permits to force the blade edges of the upper and lower blades 9 and 10 into the sheet-shaped material 5. As a result, it is possible to prevent cracks from occurring on the finished product 5b side and burrs from occurring on the cutting surface.

Of the second holding members 13 and 14 placed on the side of the lower blade 10, the front-side lower holding member 13, i.e., the lower holding member to be brought into contact with the finished product 5b side of the sheet-shaped material 5 has a height in a non-deformed state so that the upper surface of the front-side lower holding member 13 is placed slightly above the blade edge of the lower blade 10. Such a deviation of the upper surface of the front-side lower holding member 13 from the blade edge of the lower blade 10 permits to adjust the depth of the notch when cutting the sheet-shaped material 5 with the use of the upper and lower blades 9 and 10. Of the second holding members 13 and 14 placed on the side of the lower blade 10, the rear-side holding member 14, i.e., the lower holding member to be brought into contact with the useless end portion 5a side of the sheet-shaped material 5 has a height in a non-deformed state, which is smaller than the height of the front-side lower holding member 13 so that the upper surface of the rear-side lower holding member 14 is placed slightly below the blade edge of the lower blade 10. Such a specific arrangement causes force applied on the useless end portion 5a side from below to decrease in comparison with force applied on the finished product 5b side from below, leading to a smooth shearing action by means of the upper and lower blades 9 and 10. The entire holding force by which the sheet-shaped material 5 is held during the cutting operation, reduces, thus making it possible to prevent the sheet-shaped material 5 from whitening. The front and rear-side lower holding members 13 and 14, which are formed of material having an excellent cushioning property, such as cork, rubber or the like, are adhered on the lower clamping members 18a and 18b.

The first holding members 11 and 12 placed on the opposite sides, i.e., the front and rear sides of the upper blade 9 have substantially the same height so that the lower surfaces of the holding members 11 and 12 are substantially identical in level with the blade edge of the upper blade 9. The front-side upper holding member 11, i.e., the upper holding member to be brought into contact with the finished product 5b side of the sheet-shaped material 5 is disposed so as to face the portion of the lower blade 10, which extends from the blade edge of the lower blade 10 to the secondary face thereof. The front-side upper holding member 11, which is formed of material having an excellent cushioning property, such as cork, rubber or the like, is adhered on the upper clamping member 17a. The rear-side upper holding member 12, i.e., the upper holding member to be brought into contact with the useless end portion 5a of the sheet-shaped material 5 has a laminate structure having the lower layer 12a and the upper layer 12b. The lower layer 12a is formed of material having higher hardness than the upper layer 12b. Such a higher hardness of the lower layer 12a, which provides the holding member 12 with the lower surface having a higher hardness, enhances the hearing action with the use of the upper and lower blades 9 and 10, in cooperation with the feature that the rear-side lower holding member 14, which face the rear-side upper holding member 12 in the vertical direction, has a relatively small height. More specifically, the rear-side upper holding member 12 has a two-layer structure provided with the lower layer 12a, which is formed of a plate of metal such as aluminum or the like and to be brought into contact with the useless end portion 5a of the sheet-shaped material 5, on the one hand, and with the upper layer 12b, which is formed of material having an excellent cushioning property such as neoprene in the form of sponge or the like to support the above-mentioned metallic plate on the upper base member 15, on the other hand.

The front-side lower holding member 13 and the rear-side lower holding member 14 are kept in their appropriate positions by means of displacement prevention members 20 and 21 abutting on the holding members 13 and 14, respectively, so as to prevent the holding members 13 and 14 from being displaced in the traveling direction of the sheet-shaped material 5, even when they come into contact with the sheet-shaped material 5 during the cutting process. The displacement prevention members 20 and 21, which are secured on the lower clamping members 18a and 18b, respectively, have a frame-shape so as to surround the holding members 13 and 14, respectively. Prevention of displacement of the holding members 13 and 14 in the traveling direction of the sheet-shaped material 5 during the cutting process results in prevention of occurrence of cracks on the finished product 5b side. The similar displacement prevention members to the members 20 and 21 may also be disposed for the upper holding members 11 and 12, which are placed on the opposite sides of the upper blade 9.

The supply unit 8 for supplying the sheet-shaped material 5 has two sheet-placing tables 22 and 23, two robots and sheet-guide plates 24, 25 and 26, as shown in FIGS. 1 and 2. The two sheet placing tables 22 and 23 are disposed on the opposite sides at the front side of the sheet cutting apparatus. The robots are disposed between the sheet placing tables 22, 23 and the cutting unit 7 in the similar manner as the sheet placing tables 22 and 23. The sheet guide plates 24, 25 and 26 are disposed so as to abut on the cutting unit 7.

The sheet placing tables 22 and 23 are horizontal plates, which are mounted on the frames 27 and 28, respectively. The sheet placing tables 22 and 23 have rectangular recesses 22a and 23a. Suction cups 29 . . . 29 and 30 . . . 30 are disposed along the recesses 22a and 23a, respectively, so as to be directed upward. The sheet-placing table 22 is slidably mounted on a pair of guide rails 31 and 31, which are fixed horizontally on the frame 27 so as to extend longitudinally. The other sheet-placing table 23 is also slidably mounted on a pair of guide rails 32 and 32, which are fixed horizontally on the frame 28 so as to extend longitudinally. The sheet placing tables 22 and 23 are slidable in a reciprocating manner from the respective first positions as shown in solid lines in FIG. 1 to the respective second positions one of which is only shown in two-dot chain lines in the same figure along the guide rails 31, 31 and 32, 32 by the driving of air cylinders 33 and 34 connected to the frames 27 and 28, respectively. Holding plates 35 and 36 for holding the sheet-shaped material 5 from below are placed in the recesses 22a and 23a of the sheet placing tables 22 and 23, respectively. The holding plates 35 and 36 are movable in the vertical direction between the respective first positions at which the sheet placing tables 22 and 23 are flush with the upper surfaces of the sheet placing tables 22 and 23, that define the recesses 22a and 23a and the respective second positions, which are placed below the above-mentioned first positions, by the driving of the other air cylinders 37 and 38. The operation of the sheet placing tables 22 and 23 will be described below. When the sheet-shaped materials 5 and 5 as the semi-finished product shown in FIGS. 7(C) and 8(A) are put on the sheet placing tables 22 and 23, which are in a stand-by condition in the positions shown in solid lines by an operator or the other device, the suction cups 29 . . . 29 and 30 . . . 30 provided at the periphery of the recesses 22a and 23a suck the sheet-shaped materials 5 and 5 to hold stationarily them on the sheet placing tables 22 and 23. At this time, the holding plates 35 and 36 have already ascended in the recesses 22a and 23a to hold the sheet-shaped materials 5 and 5 from below so as to prevent them from sagging down until the suction cups 29 . . . 29 and 30 . . . 30 suck the sheet-shaped materials 5 and 5. After the suction cups 29 . . . 29 and 30 . . . 30 suck the sheet-shaped materials 5 and 5, the holding plates 35 and 36 descend in the recesses 22a and 23a. Then, the sheet placing tables 22 and 23, which hold the sheet-shaped materials 5 and 5 move on the guide rails 31, 31 and 32, 32 to the respective second positions one of which is only shown in the two-dot chain lines. The sheet-shaped materials 5 and 5 placed on the sheet placing tables 22 and 23 are passed to the subsequent robots in the respective second positions on of which is only shown in the two-dot chain lines, and then, the sheet placing tables 22 and 23 return to the respective first original positions. The operations described above of the two sheet placing tables 22 and 23 are repeated.

The robots may be for example sequence robots controlled by a sequential control. A programmable controller or the like may be used as the sequential control device. Robot bodies 37 and 47, which are disposed on the sheet placing tables 22 and 23, respectively, are alternately and reciprocally movable along a rail 40 as shown in one-dot chain lines in FIG. 1 from the rear side of the sheet placing tables 22 and 23 to the front side of the cutting unit 7. The above-mentioned rail 40 branches off into two parallel directions. The robots have their hands 41 and 42, respectively. The hands 41 and 42 match with the recesses 22a and 23a of the sheet placing tables 22 and 23, which move to reach the second positions one of which is only shown in the two-dot chain lines. The hands 41 and 42 are provided on their upper surfaces with a plurality of suction cups 43 . . . 43 and 44 . . . 44 for sucking the sheet-shaped material 5. The suction cups 43 . . . 43 and 44 . . . 44 stand upward.

Operation of the robots will be described below. First, the hand 41 of the left-hand robot body 39, which stands by in the first position as shown in the solid lines, enters the recess 22a of the left-hand sheet placing table 22, which has moved to reach the second position as shown in the two-dot chain lines, to receive the sheet-shaped material 5. The suction cups 43 . . . 43 suck the sheet-shaped material 5 thus received. Suction of the sheet-shaped material by means of the suction cups 29 . . . 29 of the sheet placing table 22 is simultaneously released. The robot body 39 moves in front of the cutting unit 7 on the rail 40 and then stops moving. Then, the hand 41 puts the sheet-shaped material 5 supported between the upper and lower blades 9 and 10. The upper blade 9 descends to cut a side of the sheet-shaped material 5, i.e., the useless end portion 5a off from the sheet-shaped material 5 in cooperation with the lower blade 10.

The cutting operations of the useless end portions 5a are carried out along the cutting lines CL1, CL2, CL3 and CL4 as shown in FIG. 8(A) in this order. More specifically, the useless end portion 5a is cut first along the cutting line CL1. The place of the useless end portion 5a corresponds to the front end of the sheet-shaped material 5 on the side of the cutting line CL1, which passes between the nip rollers 4 and 4 as shown in FIG. 7(B). A large amount of superfluous resin 2a adheres on such a front end of the sheet-shaped material 5.

After completion of the cutting operation of the useless end portion Sa along the cutting line CL1, the robot body 39 goes back to a turning area 40a on the rail 40. Then, the hand 41 is turned by 180 degrees and the robot body 39 advances to the side of the cutting unit 7 again. Here, another useless end portion 5a is cut along the cutting line CL 2 by means of the upper and lower blades 9 and 10 of the cutting unit 7. The useless end portion 5a thus cut on the side of the cutting line CL2 has the largest amount of superfluous resin 2a.

Then, the robot body 39 goes back again to the turning area 40a on the rail 40. The hand 41 is then turned by 90 degrees and the robot body 39 advances to the side of the cutting unit 7 again. Here, further another useless end portion 5a is cut along the cutting line CL 3 by means of the upper and lower blades 9 and 10 of the cutting unit 7.

Then, the robot body 39 goes back again to the turning area 40a on the rail 40. The hand 41 is then turned by 180 degrees and the robot body 39 advances to the side of the cutting unit 7 again. Here, still further another useless end portion 5a is cut along the cutting line CL 4 by means of the upper and lower blades 9 and 10 of the cutting unit 7.

An amount of superfluous resin 2a adhering on each of the useless end portions Sa cut along the cutting lines 3 and 4 is smaller than an amount of superfluous resin 2ax, 2ay adhering on the useless end portions 5a cut along the cutting lines 1 and 2. When a pair of opposing sides, i.e., the useless end portions 5a having a large amount of superfluous resin 2ax, 2ay are cut off first along the cutting lines CL 1 and 2 in this order, and then the remaining pair of opposing sides, i.e., the useless end portions 5a having a small amount of superfluous resin 2a are cut off along the cutting lines CL 3 and 4 in this order, the amount of superfluous resin 2a, 2ax, 2ay adhering on the useless end portion to be cut along the cutting line CL 3 or 4 has a small influence on the cutting efficiency in comparison with the case where the cutting operation is carried out along the cutting lines CL 3, 4, 1 and 2 in this order. Accordingly, a smooth cutting operation is ensured, thus appropriately preventing cracks from occurring.

As a result, there is obtained a sheet-shaped material 6 as the finished product as shown in FIG. 8(B). The robot body 39 returns to the original position, while maintaining the state that the suction cups 43 . . . 43 of the hand 41 suck the sheet-shaped material 6 as the finished product. Then, the sheet-placing table 22, which stands by in the second position as shown in the two-dot chain lines, receives the sheet-shaped material 6 thus obtained. The sheet-placing table 22 then returns to the first position as shown in the solid lines. The operator takes the sheet-shaped material 6 from the sheet-placing table 22 and then places a new sheet-shaped material 5 as the semi-finished product on the sheet-placing table 22.

A new sheet-shaped material 5 is supplied from the right-hand sheet-placing table 23 to the hand 42 of the robot body 47, during operation of the left-hand robot body 39. The right-hand robot body 47 stands by in a right-hand stand-by area 40b on the rail 40, while holding the sheet-shaped material 5. The right-hand robot body 47 moves to the cutting unit 7, after the left-hand robot body 39 has left the cutting unit 7 and then passed through the turning area 40a toward a left-hand stand-by area 40b.

The sheet-guide plates 24, 25 and 26 are provided horizontally along the traveling route of the robot bodies 39 and 47, i.e., the rail 40. The sheet-shaped material 5 tends to project from the periphery of the hand 41 or 42 of the robot to sag down. The sheet-guide plates 24, 25 and 26 however prevent the sheet-shaped material 5 from sagging down remarkably so as to keep the entirety of the sheet-shaped material 5 substantially in the flat state. Such a structure makes it possible to travel the sheet-shaped material 5 as the semi-finished product, which is sucked by the hand 41 or 42, in substantially the flat state to the cutting unit 7, while guiding the sheet-shaped material 5 by means of the sheet-guide plates 24, 25 and 26. It is also possible to discharge the sheet-shaped material 6 as the finished product onto the sheet placing table 22 or 23 in substantially the flat state, while guiding the sheet-shaped material 6 by means of the sheet-guide plates 24, 25 and 26.

The supply unit 8 for the sheet-shaped material 5 supplies alternately the sheet-shaped materials 5 from the two supply sources to the upper and lower blades 9 and 10, so as to reduce a period of time required to supply the sheet-shaped materials 5 to the upper and lower blades 9 and 10 in comparison with a case where the single sheet-shaped material is supplied from the single supply source to the cutting unit, thus improving the cutting efficiency.

In the process for forming the sheet-shaped material 5 as shown in FIGS. 7(A), 7(B) and 7(C), a metallic mold serving as the forming die 1 is previously heated in order to improve fluidity of the ultraviolet ray curing type resin 2 on the forming die 1. As a result, the sheet-shaped material 5 as the semi-finished product removed from the forming die has a high temperature than a room temperature. A cutting operation, which is carried out by means of the cutting apparatus after the lapse of time during which the temperature of the sheet-shaped material 5 as the semi-finished product decreases to the room temperature, makes it possible to obtain a finished product having a standardized size. Such a cutting operation leads to a low manufacturing efficiency. A cutting operation, which is carried out in a state that the sheet-shaped material 5 as the semi-finished product has a higher temperature than the room temperature, accompanies shrinkage of the sheet-shaped material 6 as the finished product, thus making it impossible to provide any finished product having the standardized size. In view of these circumstances, the cutting apparatus of the present invention for cutting the sheet-shaped material 5 is provided with a device described below so that the cutting operation can be carried out in a state that the sheet-shaped material S as the semi-finished product 5 has a higher temperature as increased than the room temperature, in anticipation of shrinkage of the sheet-shaped material 5.

More specifically, there are provided temperature sensors 45 and 46 for detecting temperature of the sheet-shaped material 5 supplied into the cutting apparatus and with a computing unit for operating extent of expansion of the sheet-shaped material 5 on the basis of the signals from the temperature sensors 45 and 46. The temperature sensors 45 and 46, which are for example an infrared radiation thermometer, are mounted on the upper side of the supply unit 8 for supplying the sheet-shaped material 5 as shown in FIGS. 1 and 2. The computing unit, which is provided in a control device of the above-described robot, calculates an amount of expansion ΔL in accordance with the following formula to output the same:

ΔL=L×α×(t−t₀)

wherein, “α” is coefficient of linear expansion of the sheet-shaped material 5, “t” is a temperature of the sheet-shaped material when the cutting operation is carried out, “t₀” is a room temperature and “L” is a length of the sheet-shaped material 5 at a room temperature. The value of “t−t₀” is measurable by means of the temperature sensors 45 and 46. The value of “α” is available through an experiment or the like, which has previously been made. The value of “L” is determined on the basis of the standard of the finished product.

The calculation results according to the above-mentioned formula are reflected in the control of the robot with the use of the control device. Especially, the feeding amount of the sheet-shaped material 5 into the space between the upper and lower blades 9 and 10 is adjusted in accordance with the calculation results.

As shown in FIG. 8(A), a large amount of superfluous resin 2ax adheres on the useless end portion 5a on the front side of the sheet-shaped material 5 in a direction of an arrow “A” and a larger amount of superfluous resin 2ay adheres on the useless end portion 5a on the rear side of the sheet-shaped material 5 in the same direction. Curing of the superfluous resin 2ax and 2ay by irradiation of ultraviolet ray causes generation of heat through polymerization. Quantity of heat increases in proportion to an amount of resin. As a result, an amount of expansion on the side of superfluous resin 2ay of the sheet-shaped material 5 is larger than that on the side of superfluous resin 2ax thereof.

In case where difference in expansion of the sheet-shaped material due to difference in quantity of heat generated through polymerization is not negligible, measurement of temperature are made in places corresponding to the cutting lines CL1 and CL2 of the sheet-shaped material 5 to determine expansion of the respective portions, i.e., each of the front half portion and the rear half portion of the sheet-shaped material 5 in the direction “A” in FIG. 8(A) so that a cutting operation is carried out along the cutting lines CL1 and CL2 in anticipation of expansion of the respective portions. More specifically, the temperature sensor 45 and 46 detect temperature of the front half portion and the rear half portion corresponding to the cutting lines CL1 and CL2, respectively. The computing unit calculates an amount of expansion of each of the above-mentioned portions. The supply unit 8 supplies the sheet-shaped material 5 into the cutting unit having the first and second blades 9 and 10 based on the output from the computing unit.

The sheet-shaped materials 6 as the finished product, which has been cut by means of the cutting apparatus of the present invention, are cooled to the room temperature to shrink, thus providing a standardized size as desired.

Now, a sequential operation of the above-mentioned cutting apparatus of the present invention will be described below.

Each of the sheet-shaped materials 5 as the semi-finished product shown in FIG. 7(C) and FIG. 8(A), which have been manufactured in accordance with the processes as shown in FIGS. 7(A), 7(B) and 7(C), is placed on each of the holding plates 35 and 36, which are placed in the recesses 22a and 23a of the supply unit 8 as shown in FIG. 1, respectively, in a state that the sheet-shaped materials 5 have a higher temperature than the room temperature or are cooled to the room temperature.

The sheet placing tables 22 and 23 stationarily hold the sheet-shaped materials 5 with the use of the suction cups 29 . . . 29 and 30 . . . 30. Then, the holding plates 35 and 36 descend below the sheet placing tables 22 and 23. The sheet placing tables 22 and 23 move from the respective first positions as shown in the solid lines to the respective second position one of which is shown in the two-dot chain lines, while holding the sheet-shaped materials 5. The hands 41 and 42 of the robots enter the recesses 22a and 22b of the sheet placing tables 22 and 23, respectively.

The hands 41 and 42 of the robots receive the sheet-shaped materials 5 from the sheet placing tables 22 and 23, respectively, and then, the robot bodies 39 and 47 moves to the cutting unit 7 on the rail 40. The robot body 39 or 47 moves reciprocally between the turning area 40a and a cutting area 40c, which is in the vicinity of the cutting unit 7, to put the respective sides of the sheet-shaped material 5, which has been held by means of the hand 41 or 42, into the space between the upper and lower blades 9 and 10.

In case where the sheet-shaped material 5 is cooled to the room temperature, the feeding amount of the sheet-shaped material 5 is calculated on the basis of the standardized size of the finished product. In case where the sheet-shaped material 5 has a higher temperature than the room temperature, the sheet-shaped material 5 is supplied at a relatively small feeding amount in anticipation of an amount of shrinkage calculated by the computing unit on the basis of the temperature sensors 45 and 46.

The robot body 39 or 47 first reaches the cutting area 40c, the sheet-shaped material 5 is cut along the cutting line CL 1 as shown in FIG. 8(A).

Such a cutting process will be described below on the basis of FIGS. 5 and 6. The sheet-shaped material 5 is placed so that its product 5a side rests on the front-side lower holding member 13 for the lower blade 10 (see FIGS. 3, 4, 5(A) and 6(A)). The upper blade 9 descends together with the upper clamping members 17a and 17b and the upper base member 15. The sheet-shaped material 5 is stationarily held from the opposite surfaces by means of the holding members 11, 12, 13 and 14. A deep notch is then formed by means of the upper and lower blades 9 and 10 (see FIGS. 5(B) and 6(B)). The upper holding member 12, which is disposed on the rear side of the upper blade 9 and has the lower layer 12a formed of hard material, makes it possible to strongly urge the sheet-shaped material 5 against the lower blade 10, irrespective of existence of the portion of the superfluous resin 2a cured. In addition, the front-side lower holding member 13 for the lower blade 10 has a height in a non-deformed state so that the upper surface of the front-side lower holding member 13 is placed slightly above the blade edge of the lower blade 10. Such a deviation of the upper surface of the front-side lower holding member 13 from the blade edge of the lower blade 10 permits the upper blade 9 to come into contact with the sheet-shaped material 5 prior to contact of the lower blade 10 with the sheet-shaped material 5, thus adjusting the depth of the notch when cutting the sheet-shaped material 5 with the use of the upper and lower blades 9 and 10.

The upper blade 9 stops in a prescribed position so as not to come into contact with the lower blade 10 (see FIGS. 5(C) and 6(C)), and the portion of the sheet-shaped material 5, which corresponds to the gap between the blade edges of the upper and lower blade 9 and 10 that have been put in the closest position, is broken without cutting action of the upper and lower blades 9 and 10.

After completion of the cutting operation of the sheet-shaped material 5 along the cutting line CL 1, the robot body 39 or 47 goes back to the turning area 40a. Then, the hand 41 or 42 is turned by 180 degrees and the robot body 39 or 47 moves again to the cutting area 40c to put the sheet-shaped material 5 into the gap between the upper and lower blades 9 and 10. In this state, the upper and lower blades 9 and 10 cut the sheet-shaped material 5 along the cutting line CL 2. Then, the robot body 39 or 47 goes back again to the turning area 40a. Then, the hand 41 or 42 is turned by 90 degrees and the robot body 39 or 47 moves again to the cutting area 40c to put the sheet-shaped material 5 into the gap between the upper and lower blades 9 and 10. In this state, the upper and lower blades 9 and 10 cut the sheet-shaped material 5 along the cutting line CL 3. Then, the robot body 39 or 47 goes back again to the turning area 40a. Then, the hand 41 or 42 is turned by 180 degrees and the robot body 39 or 47 moves again to the cutting area 40c to put the sheet-shaped material 5 into the gap between the upper and lower blades 9 and 10. In this state, the upper and lower blades 9 and 10 then cut the sheet-shaped material 5 along the cutting line CL 4. As a result, there is obtained the sheet-shaped material 6 as the finished product as shown in FIG. 8(B). The robot body 39 or 47 returns to the original position, while maintaining the state that the suction cups 43 . . . 43 of the hand 41 suck the sheet-shaped material 6 as the finished product. Then, the sheet-placing table 22 or 23, which stands by in the second position as shown in the two-dot chain lines, receives the sheet-shaped material 6 thus obtained.

The sheet-placing table 22 or 23 then returns to the first position as shown in the solid lines, while maintaining the suction condition of the sheet-shaped material 6. The operator takes the sheet-shaped material 6 from the sheet-placing table 22 or 23 and then places a new sheet-shaped material 5 as the semi-finished product on the sheet-placing table 22 or 23.

The left-hand and right-hand robot bodies 39 and 47 are controlled so as not to interfere with each other so that a cutting operation of the sheet-shaped material 5 transferred by one of the robot bodies 39 and 47 is carried out, while the other of the robot bodies 38 and 47 stands by in the stand-by area 40b on the rail 40. The one of the robot bodies 39 and 47 moves to the turning area 40a and the cutting area 40c, after the other of the robot bodies 39 and 47 has put the sheet-shaped material 6 as the finished product from the cutting unit 7 and then moved toward the stand-by area 40b.

The above-described operations are repeated to manufacture the sheet-shaped materials 6 as the finished product.

According to the present invention as described in detail, the method of the present invention for cutting a sheet-shaped material, comprises the steps of: (a) measuring, immediately before cutting a sheet-shaped material heated, temperature of the sheet-shaped material; (b) determining expansion of the sheet-shaped material based on said temperature thus detected and a room temperature; and (c) cutting the sheet-shaped material in anticipation of said expansion thus determined. It is therefore possible to cut the sheet-shaped material immediately after formation thereof without waiting until the temperature of the sheet-shaped material descends to the room temperature, to provide a finished product having the standardized size, thus improving manufacturing efficiency. In addition, it is possible to cut the sheet-shaped material at a higher temperature than the room temperature, and hence to prevent cracks from occurring on the finished product even when the sheet-shaped material has a high hardness.

In accordance with the second aspect of the present invention, the step (a) comprises measuring the temperature of portions of the sheet shaped-material, which correspond to a plurality of prescribed cutting lines along which the sheet-shaped material is to be cut; the step (b) comprises determining expansion of each of the portions of the sheet-shaped material; and the step (c) comprises cutting the sheet-shaped material along the prescribed cutting lines in anticipation of the expansion of each of the portions of the sheet-shaped material. It is therefore possible to carry out an appropriate cutting operation to provide the finished product having the standardized size even when the expansions of the above-mentioned portions of the sheet-shaped material, which correspond to the cutting lines, differ from each other.

According to the third aspect of the present invention, the apparatus for cutting a sheet-shaped material comprises: a cutting unit having a pair of blades; a temperature sensor for measuring temperature of a sheet-shaped material heated; a computing unit for calculating expansion of the sheet-shaped material based on said temperature measured by said temperature sensor and a room temperature; and a supply unit for supplying the sheet-shaped material into said cutting unit based on output from said computing unit. It is therefore possible to automatically measure the temperature of the sheet-shaped material and cut it smoothly to an appropriate size in anticipation of shrinkage.

According to the features of the forth aspect of the present invention, the temperature sensor measures the temperature of the portions of the sheet shaped material, which correspond to the cutting lines, the computing unit determines expansion of each of these portions and the supply unit supplies the sheet-shaped material into the cutting unit based on the signals for the portions from the computing unit. It is therefore possible to carry out an appropriate cutting operation to provide the finished product having the standardized size even when the expansions of the above-mentioned portions of the sheet-shaped material, which correspond to the cutting lines, for example the front and rear half portions thereof, differ from each other.

The entire disclosure of Japanese Patent Application No. 2000-336542 filed on Nov. 2, 2000 including the specification, claims, drawings and summary is incorporated herein by reference in its entirety.

What is claimed is:

1. A method for cutting a sheet-shaped material, comprising the steps of:
(a) measuring, immediately before cutting a sheet-shaped material heated, temperature of the sheet-shaped material;
(b) determining expansion of the sheet-shaped material based on said temperature thus detected and a room temperature; and
(c) cutting the sheet-shaped material in anticipation of said expansion thus determined.

2. The method as claimed in claim 1, wherein:
said step (a) comprises measuring the temperature of portions of the sheet shaped-material, which correspond to a plurality of prescribed cutting lines along which the sheet-shaped material is to be cut;
said step (b) comprises determining expansion of each of said portions of the sheet-shaped material; and
said step (c) comprises cutting the sheet-shaped material along said prescribed cutting lines in anticipation of said expansion of each of said portions of the sheet-shaped material.

3. An apparatus for cutting a sheet-shaped material, comprising:
a cutting unit having a pair of blades;
a temperature sensor for measuring temperature of a sheet-shaped material heated;
a computing unit for calculating expansion of the sheet-shaped material based on said temperature measured by said temperature sensor and a room temperature to output a signal; and
a supply unit for supplying the sheet-shaped material into said cutting unit based on said signal from said computing unit.

4. The apparatus as claimed in claim 3, wherein:
said temperature sensor has a function of measuring the temperature of portions of the sheet shaped-material, which correspond to a plurality of prescribed cutting lines along which the sheet-shaped material is to be cut;
said computing unit has a function of determining expansion of each of said portions of the sheet-shaped material to output signals for said portions; and
said supply unit has a function of supplying the sheet-shaped material into said cutting unit based on said signals for said portions from said computing unit.
